(19) United States
(12) Patent Application Publication
(10) Pub. No.: US 2026/0067795 A1
(43) Pub. Date: Mar. 5, 2026

(54) METHOD AND SYSTEM FOR RE-DISPATCHING E2 NODES TO RAN INTELLIGENT CONTROLLER SERVICES IN A MOBILE NETWORK

(71) Applicant: QUANTA CLOUD TECHNOLOGY INC., Taipei City (TW)

(72) Inventors: Chia-Hsin Huang, Taipei City (TW); Chia-Jui Lee, Taipei City (TW)

(21) Appl. No.: 18/816,634

(22) Filed: Aug. 27, 2024

(51) Int. Cl. H04W 48/18; H04W 36/30

(52) U.S. Cl. CPC H04W 48/18; H04W 36/30

(57) ABSTRACT

A system and method for ensuring reliable service for E2 nodes in a radio access network. The system includes a first near real time radio access network intelligent controller. An E2 node is in network communication with the first near real time radio access network intelligent controller. The E2 node includes a configuration file with the network address of the first near real time radio access network intelligent controller. A second near real time radio access network intelligent controller has a network address. The network address of the second near real time radio access network intelligent controller is supplied to the E2 node. Through a re-dispatch procedure, the E2 node establishes network communication with the second near real time radio access network intelligent controller. Alternatively, the second intelligent controller may initiate the re-dispatch procedure to establish network communication with the E2 node.

### TECHNICAL FIELD

The present disclosure relates generally to mobile wireless networks. More particularly, aspects of this disclosure relate to a system that allows E2 nodes in a radio access network (RAN) system to be re-distributed to one of several near real time RAN intelligent controllers.

### BACKGROUND

Mobile devices (e.g., cell phones) have become an indispensable tool for daily communication, entertainment, banking, and various other essential activities. Such activities require high quality of services (QoS, e.g., high bandwidth and low latency) for the mobile devices. In order to meet demands for wireless data traffic that the current 4G communication systems are unable to meet, the next generation communication system termed a 5G communication system, or 5G for short, was developed and standardized by the 3^{rd} generation partnership project (3GPP). Based on that project, the open radio access network (O-RAN) alliance further defines a radio access network (RAN) interface and an O-RAN architecture that allows interoperability of O-RAN solutions.

An O-RAN system may refer to a network system implemented based on O-RAN standards. Functions capable of being performed by a base station (eNB) of the existing 4G mobile communication systems and a base station (gNB) of a 5G mobile communication system are logically separated and implemented. An O-RAN base station providing mobile communication services is a cell site that includes a data processing unit (a digital unit or a distributed unit (DU)), a wireless transceiver (radio unit or remote unit (RU)) that communicates with user devices, and a central unit (CU) coupled to the DU. Current mobile communication requires multiple cell sites as users and traffic increase. The O-RAN system may include a RAN intelligent controller (RIC) for performing various types of management including resource allocation between the base station and a core network. The RIC is an element for improving quality of service for user equipment (UE) such as mobile devices, and may provide optimal cellular communication to the UE through the optimization of elements and resources of the O-RAN system.

A near real time radio access network intelligent controller (nRT-RIC) is a software-defined component of the Open RAN standard and is used to control and optimize RAN functions. FIG. 1 shows a known RAN system 10 that includes groups of E2 nodes 12 and 14. The E2 nodes in the E2 node groups 12 and 14 represent DUs and CUs. Each group of E2 nodes 12 and 14 are in communication with a respective nRT-RIC 16 and 18 that provide various services for the E2 nodes.

In E2 nodes such as DUs and the CUs, an E2 agent 20 acts as an interface handler enabling communication to nRT-RIC over an E2 interface 22. The E2 interface defines a set of E2 procedures enabling a near-real-time close loop automation between the nRT-RIC 16 and an E2 node in the group of E2 nodes 12. The E2 nodes also include various RAN functions 24 that offer manageability such as performance management, configuration management, and other applications 26 that perform other functions such as functions that support base station capabilities.

A service management and orchestration system 42 is the topmost management unit and manages the entire RAN system 10. The service management and orchestration system 42 includes a non-real time RIC 44. The nRT-RICs such as the nRT-RICs 16 and 18 are respectively connected to the non-real time-RIC 44 and the service management and orchestration system 42 through an A1 interface 30 and an O1 interface 32 that serve as communication interfaces. The non-real time RIC 44 enables a non-real-time control loop and the deployment of policy, guidance, and intelligent models in the nRT-RICs 16 and 18 through the A1 interface 30. Additionally, the service management and orchestration system 42 enables the manageability of all nRT-RICs and E2 nodes using the O1 interface 32.

In a large-scale open radio access network (O-RAN) communication system, nRT-RICs encounter scalability challenges since a single nRT-RIC instance may be unable to handle massive numbers of E2 nodes. Typically, a nRT-RIC instance needs to collect a set of key performance data from each of a large number of E2 nodes, analyze the data, and make optimal decisions to control the E2 nodes in near real time (10 ms to 1 second). Thus, multiple nRT-RIC instances may be employed to share computational workload. However, as defined by the standard E2 interface specification, the communication protocol between nRT-RIC and E2 nodes, an E2 node only supports a pre-configuration scheme to communicate with a single predefined nRT-RIC.

According to the E2 interface specification, an E2 node such as an E2 node 50 in the group of E2 nodes 12 is setup in relation to the nRT-RIC 16, as shown in FIG. 2. The E2 node 50 must be preconfigured with a nRT-RIC address, RIC service information, and E2 node configuration (60) before the E2 node 50 proactively establishes a connection to nRT-RIC in the E2 setup procedure. A SCTP connection between the E2 node 50 and the nRT-RIC 16 is established (62). In the E2 setup procedure, the E2 node 50 first sends a E2 setup request to inform the nRT-RIC 16 about its capabilities (i.e., configuration information) (64). The nRT-RIC 16 extracts a list of supported near real time RIC services and maps the services to the functions (66). The nRT-RIC 16 extracts a list of E2 node configuration information (68). Then, the nRT-RIC 16 stores the E2 node information. The nRT-RIC 16 then sends an E2 setup response to the E2 node 50 to acknowledge the completion of the E2 setup procedure (70). At this moment, the E2 node 50 has been registered to the nRT-RIC 16. The nRT-RIC 16 can interact with the E2 node 50. However, the known pre-configuration scheme creates barriers to flexibility, manageability, and resilience between nRT-RIC and E2 nodes. Particularly when failure or overloading events occur on a nRT-RIC such as the nRT-RIC 16, E2 nodes served by the nRT-RIC 16 such as the E2 node 50 may not maintain their quality of services and performance.

There are some current systems that address the issue of allocating a single nRT-RIC to E2 nodes, however those systems have various disadvantages. A specialized system may be developed for allocating E2 nodes, but building such specialized systems are expensive. Further such systems must be retrofitted to existing networks and may not be compatible to current specifications. In addition, new specialized systems may cause side effects of reimplementation to the existing nRT-RIC applications such as xApps.

Thus, there is a need for an E2 node re-dispatching technique based on the O-RAN E2 specification to enhance current pre-configured registration capabilities for E2 nodes. There is also a need for a system that enables a nRT-RIC instance proactively enforce an E2 node to connect to the nRT-RIC instance or any other nRT-RIC instance. There is also a need for a system that increases flexibility, manageability, and resilience of the near-real-time close loop automation between nRT-RIC and E2 nodes with compatibility to current specifications.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

One disclosed example is a radio access network including a first near real time radio access network intelligent controller having a first network address. A second near real time radio access network intelligent controller has a second network address. An E2 node is in network communication with the first near real time radio access network intelligent controller. The E2 node includes a configuration file with the first network address. A re-dispatch procedure is executed to supply the second network address to the E2 node to update the configuration file. Network communication with the second near real time radio access network intelligent controller and the E2 node is established.

A further implementation of the example network includes a non-real time radio access network intelligent controller coupled to the first and second near real time radio access network intelligent controllers. The second near real time radio access network intelligent controller is selected by the non-real time radio access network intelligent controller from a plurality of near real time radio access network controllers. Another implementation is where the first near real time radio access network intelligent controller initiates the re-dispatch procedure. The configuration file of the E2 node is updated with the second network address from the first near real time radio access network intelligent controller. Another implementation is where the second near real time radio access network intelligent controller initiates the re-dispatch procedure when the first near real time radio access network intelligent controller fails. Another implementation is where the E2 node receives the second network address from the second near real time radio access network intelligent controller during the re-dispatch procedure. Another implementation is where the E2 node is one of a plurality of E2 nodes supported by the first near real time radio access network intelligent controller. Another implementation is where the first near real time radio access network intelligent controller is in compliance with the O-RAN standards.

Another disclosed example is a method of supporting E2 nodes in a mobile communication network. Network communication is established between an E2 node with a first near real time radio access network intelligent controller. The E2 node includes a configuration file with the network address of the first near real time radio access network intelligent controller. A re-dispatch procedure is executed to supply a second network address of a second near real time radio access network intelligent controller to the E2 node. Network communication between the E2 node and the second near real time radio access network intelligent controller is established.

Another implementation of the example method is where the second near real time radio access network intelligent controller is selected from a plurality of near real time radio access network controllers by a non-real time radio access network intelligent controller coupled to the first and second near real time radio access network intelligent controllers. Another implementation is where the first near real time radio access network intelligent controller initiates the re-dispatch procedure. The configuration file of the E2 node is updated with the second network address. Another implementation is where the second near real time radio access network intelligent controller initiates the re-dispatch procedure when the first near real time radio access network intelligent controller fails. Another implementation is where the E2 node receives the second network address during the re-dispatch procedure. Another implementation is where the E2 node is one of a plurality of E2 nodes supported by the first near real time radio access network intelligent controller. Another implementation is where the first near real time radio access network intelligent controller is in compliance with the O-RAN standards.

Another disclosed example is a near-real time radio access network intelligent controller for servicing E2 nodes in a radio access network. A network interface allows communication to a first E2 node through an E2 network interface. The near-real time radio access network intelligent controller includes a database storing the IP address of another radio access network intelligent controller in the radio access network and the IP address of the first E2 node and a second E2 node. A controller executes a network function for the E2 node through the network interface. The controller executes a re-dispatch procedure that communicates with the first E2 node over the network interface to reconfigure a configuration file of the E2 node with the IP address of the second radio access network intelligent controller. A communication with the second E2 node is established. The re-dispatch procedure is executed to reconfigure the configuration file of the second E2 node with an IP address of the near-real time radio access network intelligent controller. The controller terminates the communication with the second E2 node.

Another implementation of the example near-real time radio access network intelligent controller is where the controller determines a decrease in execution of the network function. The controller initiates a request to the first E2 node to establish communication with the another near-real time radio access network intelligent controller and terminates the network communication with the E2 node. Another implementation is where the controller receives a connection request from the second E2 node. The controller establishes communication with the second E2 node and performs the network function for the second E2 node. Another implementation is where the example near-real time radio access network intelligent controller includes another network interface in communication with a non-real time radio access network intelligent controller. The near real time radio access network intelligent controller is selected by the non-real time radio access network intelligent controller from a plurality of near real time radio access network controllers to receive the connection request from the second E2 node. Another implementation is where the first E2 node is one of a plurality of E2 nodes supported by the near real time radio access network intelligent controller. Another implementation is where the near real time radio access network intelligent controller is in compliance with the O-RAN standard.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a block diagram of a prior art open radio access network (O-RAN) system that may be a mobile network;

FIG. 2 is the prior art setup procedure for an E2 node to connect to a near real time radio access network intelligent controller (nRT-RIC) in the RAN in FIG. 1;

FIG. 3 is a block diagram of an example network system that allows E2 connections from E2 nodes in different RANs to be accessed by different nRT-RICs;

FIG. 4 is process diagram of the example re-dispatch procedure initiated by a nRT-RIC, allowing an E2 node to communicate with another nRT-RIC;

FIG. 5 is a process diagram of an example procedure where a nRT-RIC requests communication and initiates a re-dispatch procedure allowing an E2 node to communicate with the nRT-RIC;

FIG. 6 is an architecture diagram of an example near-real time radio access network intelligent controller having re-dispatch capabilities; and FIG. 7 is a flow diagram of a routine that manages the example redispatch process to ensure service of E2 nodes by nRT-RICs.

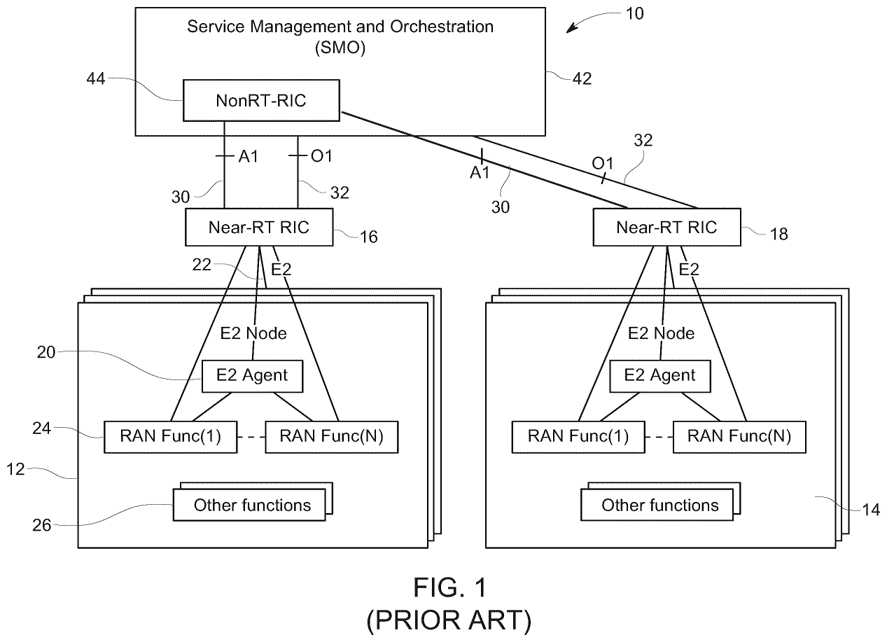

### DETAILED DESCRIPTION OF THE ILLUSTRATED EMBODIMENTS

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

The present disclosure relates to an E2 node re-dispatching technique based on the O-RAN E2 specification to support flexible registration capability for E2 nodes to different near real-time radio access network intelligent controller (nRT-RIC) in a radio access network (RAN). The example technique also enables a nRT-RIC to proactively cause an E2 node to connect to it or to another nRT-RIC. The example system enables the capabilities of flexibility, manageability, and resilience of the near-real-time close loop automation between nRT-RICs and E2 nodes. The example redispatch technique is fully compatible to the O-RAN E2 specification. This allows previous development efforts and deployment of nRT-RIC applications to be leveraged without any side effect. The example system may be deployed with minimal changes in the current O-RAN nRT-RIC framework design by adding a re-dispatch procedure to the E2 interface. The example system facilitates distribution of computational workload of E2 nodes to multiple nRT-RIC instances in a radio access network system.

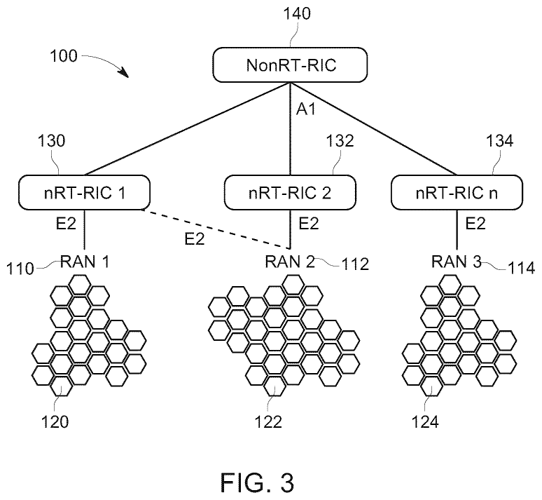

FIG. 3 shows an example mobile communication system 100 that includes radio access networks (RANs) 110, 112, and 114. Each of the RANs 110, 112, and 114 have E2 nodes 120, 122, and 124 respectively that each serve numerous user devices. Each of the E2 nodes 120, 122, and 124 in the RANs 110, 112, and 114 is managed by respective near real-time radio intelligent controllers (nRT-RICs) 130, 132, and 134 through E2 interfaces. Each of the nRT-RICs 130, 132, and 134 are connected to the non-real time radio intelligent controller 140 for non-real time monitoring and supervision. The example mobile communication system 100 allows E2 nodes in the different RANs 110, 112, and 114 to establish a connection with another nRT-RIC in the events that the original nRT-RIC is unavailable or overloaded. For example, the E2 node 122 in the RAN 112 may be connected to the nRT-RIC 130 instead of the nRT-RIC 132 if the nRT-RIC 132 is unavailable or overloaded.

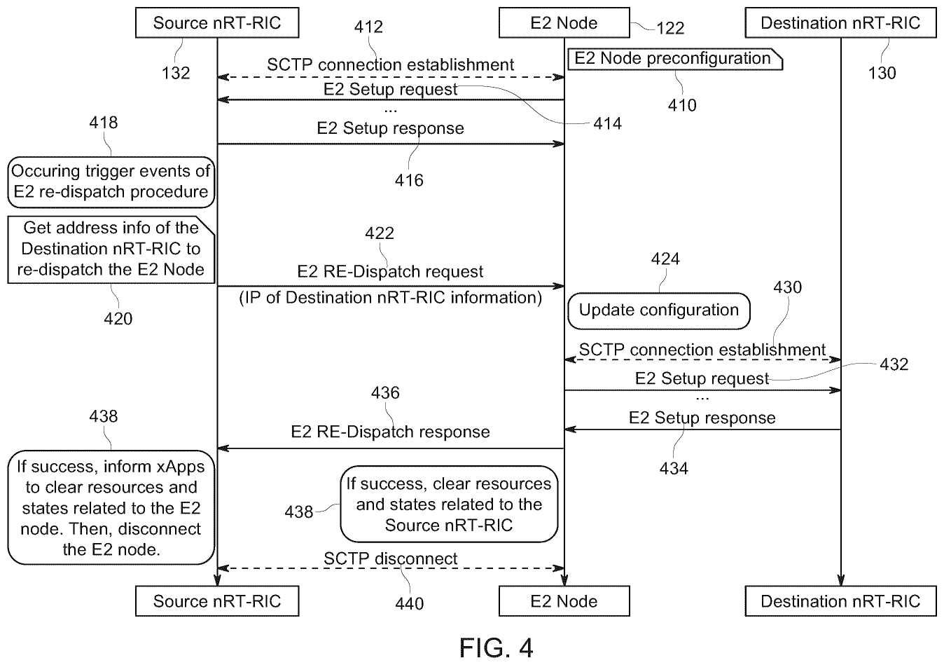

In a large-scale O-RAN communication system such as the mobile communication system 100, multiple nRT-RIC instances such as the nRT-RICs 130, 132, and 134 are employed to share the workload of serving massive numbers of E2 nodes. However, the mobile communication service may be affected when one of the nRT-RICs 130, 132, and 134 experiences a reduction in support capability. For example, a source nRT-RIC such as the nRT-RIC 132 may be currently operational, but may be overloaded or may be scheduled to go offline for maintenance or replacement. In this instance, the non-real time radio access network intelligent controller (nonRT-RIC) 140 first determines one or plurality of suitable destination nRT-RIC(s) such as the nRT-RIC 130 to take over servicing the E2 nodes currently serviced by the source nRT-RIC 132. The nonRT-RIC 140 delivers necessary information, such as the internet protocol (IP) address of the nRT-RIC 130, to the nRT-RIC 132. As will be explained, the nRT-RIC 132 can then redispatch the E2 nodes of the RAN 112 to the nRT-RIC 130 using the information from the nRT-RIC 130 as will be explained below with reference to FIG. 4.

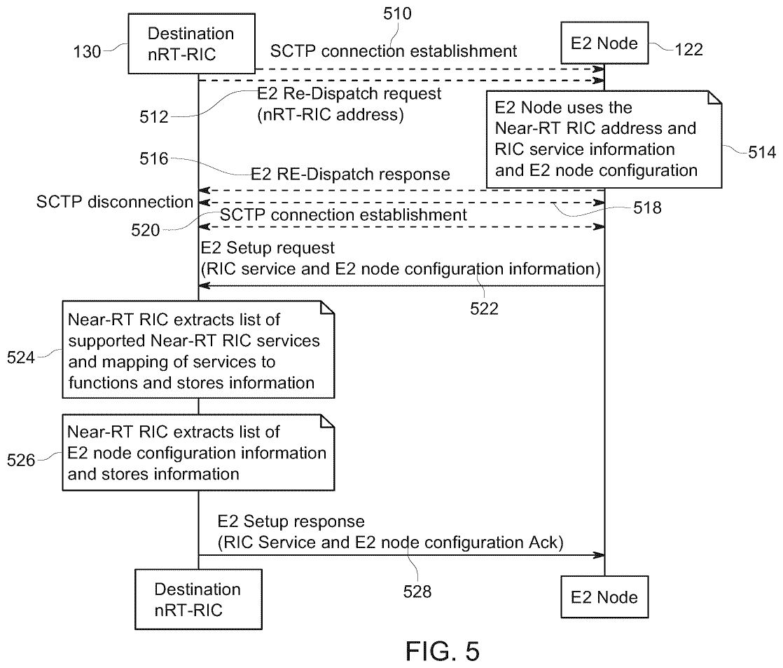

In the case that the nRT-RIC 132 fails unexpectedly, the nonRT-RIC 140 will detect the failure event. The nonRT-RIC 140 will determine one or plurality of suitable new destination nRT-RIC(s) such as the nRT-RIC 130 to serve the E2 nodes of the RAN 112 that were served by the now non-functional nRT-RIC 132. Then, the nonRT-RIC 140 provides the nRT-RIC 130 with the IP address information of the E2 nodes of the RAN 112. With the E2 node IP addresses, the nRT-RIC 130 performs a re-dispatching process to the E2 nodes of the RAN 112 and thus takes over support for the E2 nodes in the process detailed in FIG. 5.

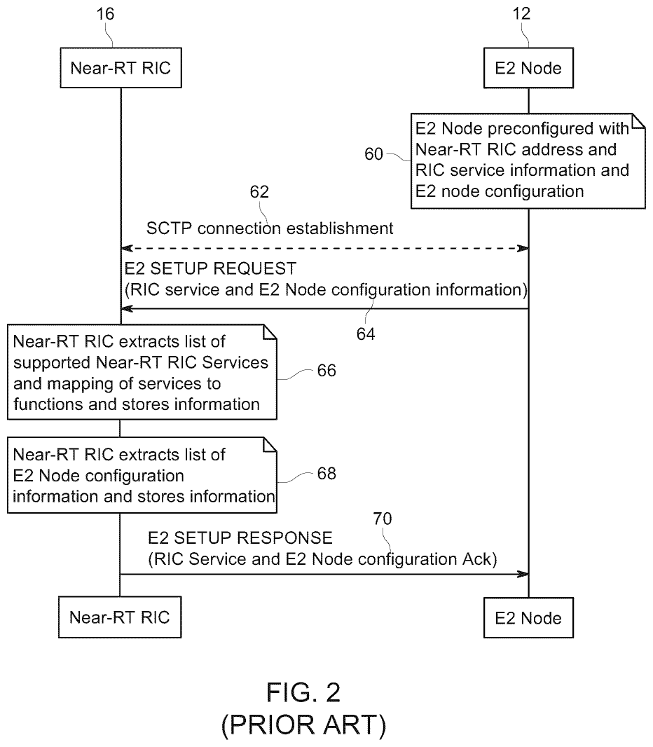

FIG. 4 shows an example re-dispatch procedure for an E2 node, such as the E2 node 122, with an initial source nRT-RIC, such as the nRT-RIC 132. The source nRT-RIC 132 provides services and support for the E2 node 122. The example re-dispatch procedure is executed after completion of the standard E2 setup procedure, which allows the E2 node 122 to be registered to the source nRT-RIC 132 as described in FIG. 2. The E2 node 122 is preconfigured with an nRT-RIC address, RIC service information, and E2 node configuration information (410). Once preconfigured, the E2 node 122 establishes an SCTP connection to the source nRT-RIC 132 using the address of the nRT-RIC from the configuration (412). The E2 node 122 sends an E2 setup request to inform the nRT-RIC 132 about its capabilities (i.e., configuration information) (414). The nRT-RIC 132 stores the E2 node information and sends an E2 setup response to the E2 node to acknowledge the completion of the E2 setup procedure (416). At this moment, the E2 node 122 has been registered to the nRT-RIC 132. The nRT-RIC 132 can therefore interact with the E2 node 122.

Assuming that the nonRT-RIC 140 in FIG. 3 detects a critical event that may disable the source nRT-RIC 132, the nonRT-RIC 140 will determine a suitable new destination nRT-RIC such as the nRT-RIC 130 to take over hosting the E2 node 122. The nonRT-RIC 140 offers information about the nRT-RIC 130 and informs the source nRT-RIC 132 to re-dispatch the E2 node 122 to the destination nRT-RIC 130. When the informed trigger event, such as an overload condition or a scheduled shut down, occurs on the nRT-RIC 132 (418), the example re-dispatch procedure may be initiated

When the informed trigger event occurs, the E2 nodes 122 served by the nRT-RIC 132 cannot maintain their quality of service to user devices because of the reduced capability of the nRT-RIC 132. The example E2 re-dispatch procedure is then executed to connect the E2 nodes 122 to a new destination nRT-RIC such as the nRT-RIC 130. The example E2 re-dispatch procedure may be added into the E2 interface of the nRT-RIC 132 to support re-dispatch capability for E2 nodes.

Once the informed trigger event is detected, the source nRT-RIC 132 gets network address information (e.g., an IP address) of another nRT-RIC that may support the E2 node (420). As explained above, the network address information for an appropriate nRT-RIC is supplied by the nonRT-RIC 140 in FIG. 3. The new nRT-RIC is selected by the nonRT-RIC 140 based on factors such as load balancing for the entire communication network. In this example, the nonRT-RIC 140 determines that the nRT-RIC 130 can support the E2 node 122 and thus provides the IP address of the nRT-RIC 130 to the nRT-RIC 132. The nRT-RIC 132 sends a re-dispatch request that includes the IP address of the destination nRT-RIC 130 to the E2 node 122 (422). The E2 node 122 then updates the configuration to include the IP address of the destination nRT-RIC 130 (424). The E2 node 122 then initiates the standard setup procedure with the destination nRT-RIC 130 using the IP address of the nRT-RIC 130.

Specifically, the E2 node 122 establishes an SCTP connection to the new destination nRT-RIC 130 (430). The E2 node 122 sends an E2 setup request to inform the nRT-RIC 130 about its capabilities (i.e., configuration information) (432). The nRT-RIC 130 stores the E2 node information and sends an E2 setup response to the E2 node 122 to acknowledge the completion of the E2 setup procedure (434). At this moment, the E2 node 122 has been registered to the new destination nRT-RIC 130. The new destination nRT-RIC 130 can therefore interact with the E2 node 122.

With the new configuration, the E2 node 122 can establish a new connection to the destination nRT-RIC 130 and enforce the E2 setup procedure. After the setup procedure is completed, the E2 node 122 sends an E2 re-dispatch response event to the source nRT-RIC 132 to confirm whether the E2 node 122 can now be served by the destination nRT-RIC 130 (436). If the confirmation is successful, the E2 node 122 and the source nRT-RIC 132 releases resources related to each other simultaneously as such resources are no longer needed (438). The source nRT-RIC 132 will then initiate a SCTP disconnect, which terminates the connection to the E2 node 122 (440). The E2 node 122 is now ready to interact with the destination nRT-RIC 130. If the confirmation fails, the source nRT-RIC 132 can initiate the example process to re-dispatch the E2 node 122 to another destination nRT-RIC such as the nRT-RIC 134 in FIG. 3 or perform exceptional handling mechanisms.

There are therefore two use cases that may allow connection of E2 nodes to another nRT-RIC by the example system. The first use case is where a source nRT-RIC instance re-dispatches the E2 nodes configured to communicate with the source nRT-RIC to another, destination nRT-RIC instance as explained above with reference to FIG. 4. This may be performed when an existing source nRT-RIC is going to be unable to support the E2 node (an informed trigger event) and thus the re-dispatch procedure allows the E2 node to be supported by another nRT-RIC.

A second use case is where a destination nRT-RIC instance requests an E2 node to connect to the destination nRT-RIC if the source nRT-RIC such as the nRT-RIC 132 that is currently serving the E2 node fails. In this case, a destination nRT-RIC such as the nRT-RIC 130 will proactively connect to the E2 node 122. This allows the configuration file of the E2 node 122 to be updated with the network address of a destination nRT-RIC such as the nRT-RIC 130 to replace the network address of the failed source nRT-RIC 132. After updating the configuration file, the connection between the destination nRT-RIC 130 and the E2 node 122 is terminated. The E2 node 122 then connects to the destination nRT-RIC 130 via the normal E2 interface specification procedure outlined in FIG. 2 with the destination nRT-RIC IP address now in the updated configuration file.

The E2 node 122 is normally serviced by a source nRT-RIC such as the nRT-RIC 132. During operation of the system, assuming that the nonRT-RIC 140 in FIG. 3 detects a critical event that causes the source nRT-RIC 132 to fail, the nonRT-RIC 140 will determine a suitable new destination nRT-RIC such as the nRT-RIC 130 or multiple new destination nRT-RICs to take over servicing the E2 nodes serviced by the source nRT-RIC such as the E2 node 122. The nonRT-RIC 140 offers information about the E2 node 122 such as the IP address of the E2 node to the destination nRT-RIC 130 and commands the destination nRT-RIC 130 to proactively re-dispatch the E2 node 122 to the destination nRT-RIC 130.

FIG. 5 shows a process diagram of the second use case where an unanticipated failure of a source nRT-RIC occurs. An initial setup is triggered by the failure of the source nRT-RIC where the destination nRT-RIC 130 will send a SCTP connection request to the E2 node 122 according to information including the IP address of the E2 node 122 provided by the nonRT-RIC 140 (510). The destination nRT-RIC 130 sends a re-dispatch request that includes network address information such as the IP address of the destination nRT-RIC 130 to the E2 node 122 (512). The E2 node 122 updates its configuration file by replacing the IP address of the source nRT-RIC 132 with the IP address of the destination nRT-RIC 130 according to the E2 re-dispatch request (514). On success of the re-dispatch request, the E2 node 122 will feedback the results to the destination nRT-RIC 130 by a E2 re-dispatch response event (516). Finally, the destination nRT-RIC 130 terminates the SCTP connection to the E2 node 122 (518).

At the moment that the E2 node 122 loses the connection to the destination nRT-RIC 130, the E2 node 122 may automatically re-initialize the E2 setup procedure to register to and interact with the destination nRT-RIC 130 using the network address of the nRT-RIC as defined by the E2 interface specifications if required. In this case, the E2 node 122 may establish a SCTP connection with the destination nRT-RIC 130 (520) based on the IP address furnished from the initial re-dispatch request from the destination nRT-RIC 130 (512). Once the SCTP connection is established, the E2 node 122 may send an E2 setup request that includes the RIC service and E2 configuration information to the destination nRT-RIC 130 (522). The nRT-RIC 130 extracts a list of the supported near real-time RIC services and maps the services to functions and stores this information in a database (524). The nRT-RIC 130 also extracts a list of E2 node configuration information and stores the configuration information (526). The destination nRT-RIC 130 then sends an E2 setup response with RIC service and E2 node configuration acknowledgement to indicate the completion of the E2 setup procedure (528). The process in FIG. 5 is only one example. Each of the destination nRT-RICs selected by the nonRT-RIC 140 will use the process in FIG. 5 to provide re-dispatch requests to all E2 nodes that the nonRT-RIC 140 assigned to the nRT-RIC in the communication network. If there is an E2 node that fails to be re-dispatched to a nRT-RIC, the nonRT-RIC 140 will find another destination nRT-RIC to repeat the re-dispatch process.

The first use case is used in preventive maintenance situation where a source nRT-RIC is able to take actions to avoid expected negative impacts from critical events. A source nRT-RIC can redispatch its E2 nodes to a destination nRT-RIC so that its E2 nodes can keep being managed by the destination nRT-RIC. This is in contrast to the conventional function of E2 protocol where E2 nodes will lose of control after the source nRT-RIC goes down because they are pre-configurated to connect to the source nRT-RIC only.

The second use case is used for failure recovery purposes. Specifically, a source nRT-RIC has no sufficient time to redispatch its E2 nodes when it goes down unexpectedly. To recover from the exceptional events, one or more destination nRT-RIC(s) will be selectively and proactively re-configured and force the E2 nodes to connect to the destination nRT-RIC(s) via the example E2 node re-dispatch procedure in FIG. 5. The nonRT-RIC 140 contacts the destination nRT-RICs to initiate the re-dispatch procedure. This causes all E2 nodes serviced by the failed source nRT-RIC to migrate to new nRT-RICs.

In both use cases, finding a sufficient and proper destination nRT-RIC, finding conditions to trigger the E2 node re-dispatch event, and exception handling, are performed by the nonRT-RIC 140 through any appropriate method. In this example, the nonRT-RIC 140 constantly collects key performance data, service availability, and resource consumption status from the nRT-RICs. The nonRT-RIC 140 may use such data to proactively find low load nRT-RICs to take over servicing effected E2 nodes for both use cases. Alternatively, an external management entity may perform the function of the nonRT-RIC 140 in determining appropriate destination nRT-RICs.

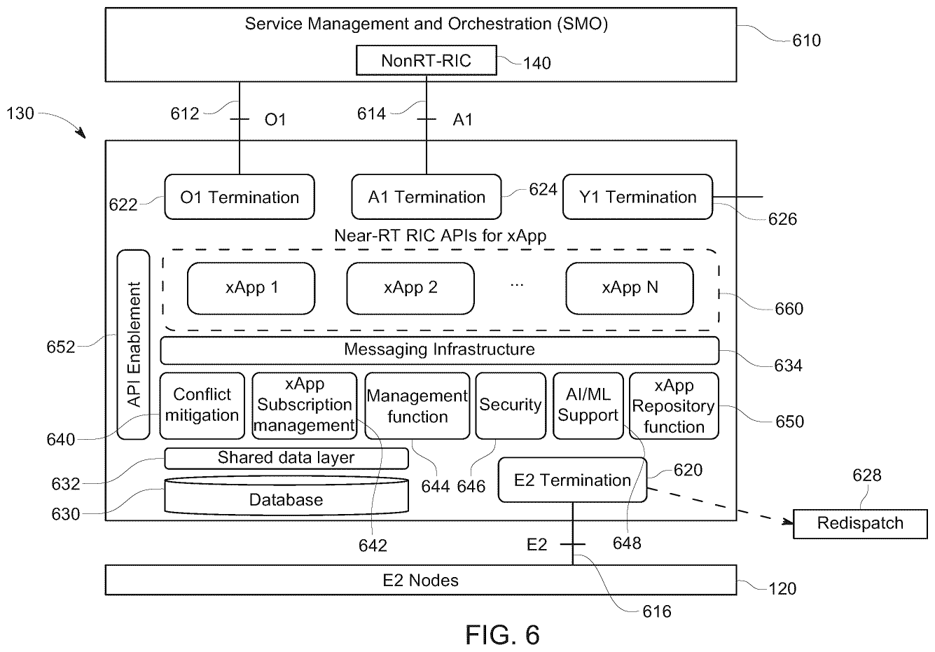

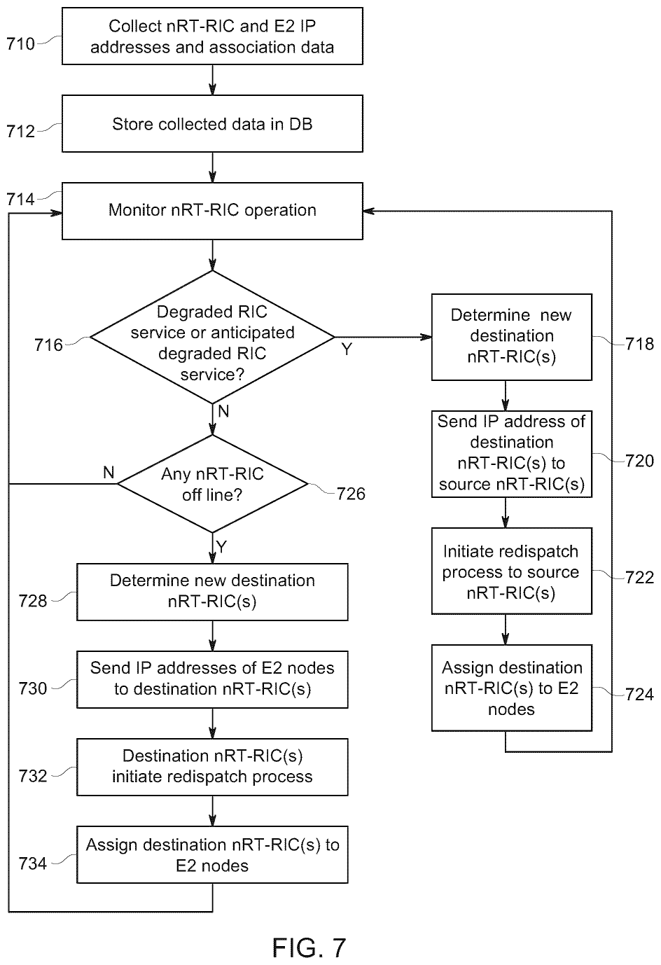

FIG. 6 shows a detailed architecture diagram of the example nRT-RIC 130 in FIG. 3. The nRT-RIC 130 is in network communication with a service management and orchestration system (SMO) 610 that includes the non-real time RAN intelligent controller (nonRT-RIC) 140. The network communication with the service management and orchestration 610 and the nonRT-RIC 140 occur through an O1 interface 612 and an A1 interface 614, respectively. The nRT-RIC 130 is also in network communication with the E2 nodes 120 through an E2 interface 616. The architecture of the nRT-RIC 130 includes an E2 termination 620, an O1 termination 622, an A1 termination 624, and a Y1 termination 626. The E2 termination (E2T) 620 is a process where the E2 interface 616 is managed and terminated. In this example, the E2 termination 620 executes a re-dispatch procedure 628 as explained above. The re-dispatch service procedure 628 can operate to update the IP address of a nRT-RIC to an E2 node configuration file via the process in FIGS. 4 and 5 such that the E2 node 120 can register to the nRT-RIC.

The nRT-RIC 130 includes a database 630, a shared data layer 632, and a messaging infrastructure 634. In this example, the database 630 may store the IP addresses of other nRT-RICs and IP addresses of re-dispatched E2 nodes that may be updated to the configuration files of E2 nodes to allow the re-dispatch process in FIGS. 4 and 5. Various functions are performed by the nRT-RIC 130 including a conflict mitigation function 640, an xApp subscription management function 642, a management function 644, a security function 646, an AL/ML support function 648, and an xApp repository function 650. The nRT-RIC 130 may execute a series of applications 660 that are xApp modules that use an API enablement 652. The applications 660 are a series of xApp modules that are pluggable functional extensions of the nRT-RIC 130, and are responsible for controlling and optimizing RAN functions and resources. The applications 660 may also participate in the re-dispatch service procedure.

The service management and orchestration system 610 manages the entire RAN system. The nRT-RICs such as the nRT-RIC 130 are connected to the nonRT-RIC 140 and the service management and orchestration system 610 through the A1 termination 624 and the O1 termination 622, respectively. The communication links formed by A1 termination 624, O1 termination 622, and E2 termination 620 are the A1, O1, and E2 interfaces 612, 614, and 616, respectively. The nonRT-RIC 140 enables a non-real-time control loop and the deployment of policy, guidance, and intelligent models in the nRT RIC 130 through the A1 termination 624. The Y1 termination 626 provides an interface between the nRT-RIC 130 and Y1 consumers. The Y1 termination 626 enables RAN analytics information exposure from the nRT-RIC 130.

The flow diagram in FIG. 7 is representative of example machine readable instructions for implementing a re-dispatch process during operation of the RAN. In this example, the machine readable instructions comprise an algorithm for execution by: (a) a processor; (b) a controller; and/or (c) one or more other suitable processing device(s). The algorithm may be embodied in software stored on tangible media such as flash memory, CD-ROM, floppy disk, hard drive, digital video (versatile) disk (DVD), or other memory devices. However, persons of ordinary skill in the art will readily appreciate that the entire algorithm and/or parts thereof can alternatively be executed by a device other than a processor and/or embodied in firmware or dedicated hardware in a well-known manner (e.g., it may be implemented by an application specific integrated circuit [ASIC], a programmable logic device [PLD], a field programmable logic device [FPLD], a field programmable gate array [FPGA], discrete logic, etc.). For example, any or all of the components of the interfaces can be implemented by software, hardware, and/or firmware. Also, some or all of the machine readable instructions represented by the flowcharts may be implemented manually. Further, although the example algorithm is described with reference to the flowchart illustrated in FIG. 7, persons of ordinary skill in the art will readily appreciate that many other methods of implementing the example machine readable instructions may alternatively be used. For example, the order of execution of the blocks may be changed, and/or some of the blocks described may be changed, eliminated, or combined.

The routine first collects IP addresses of nRT-RICs that are active and may service the E2 nodes on the network as well as the IP addresses of the E2 nodes (710). The collected data includes data on the association between the nRT-RICs and the E2 nodes. The routine then stores the collected data in the databases of all nRT-RICs with respective IP addresses of all nRT-RICs in the network (712). The routine then monitors the status of nRT-RICs in executing services for different E2 nodes (714). The routine determines whether service from a (source) nRT-RIC is being degraded or will be degraded through events such as scheduled maintenance or the load approaching the maximum (716). If service will be degraded (716), the routine determines a possible new (destination) nRT-RIC or nRT-RICs for the E2 nodes current serviced by the degraded nRT-RIC (718). The IP addresses of the destination nRT-RIC(s) are sent to the source nRT-RIC (720). The routine then causes the source nRT-RIC to initiate a redispatch process as explained in FIG. 4 to provide the destination nRT-RIC address to the E2 node (722). The routine causes a new destination nRT-RIC to be reassigned to each of the E2 nodes thus ensuring system operation (724). The routine then loops back to continue to monitor the status of nRT-RICs (714).

The routine also determines if any nRT-RIC goes off line (726). If a (source) nRT-RIC goes off line, the routine determines a new (destination) nRT-RIC or nRT-RICs for the E2 nodes serviced by the off line nRT-RIC (728). The new destination nRT-RIC or nRT-RICs is selected by the nonRT-RIC based on factors such as network and service load (728). The IP addresses of the effected E2 nodes are sent to the selected destination nRT-RIC or nRT-RICs (730). The routine causes the new destination nRT-RIC or nRT-RICs to initiate a re-dispatch process (732) as detailed in FIG. 5. The routine causes the E2 nodes to be reassigned to the new destination nRT-RIC(s) thus ensuring system operation (734). The routine then loops back to continue to monitor the status of nRT-RICs (714).

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In one or more embodiments, computer-executable instructions are executed on a general purpose computer to turn the general purpose computer into a special purpose computer implementing elements of the disclosure. The computer executable instructions may be, for example, binaries, intermediate format instructions such as assembly language, or even source code. Although the subject matter has been described in language specific to structural marketing features and/or methodological acts, it is to be understood that the subject matter defined in the appended claims is not necessarily limited to the described marketing features or acts described above. Rather, the described marketing features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as an un-subscription model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing un-subscription model can be composed of various characteristics such as, for example, on-demand self-service, broad network access, resource pooling, rapid elasticity, measured service, and so forth. A cloud-computing un-subscription model can also expose various service un-subscription models, such as, for example, Software as a Service (“SaaS”), a web service, Platform as a Service (“PaaS”), and Infrastructure as a Service (“IaaS”). A cloud-computing un-subscription model can also be deployed using different deployment un-subscription models such as private cloud, community cloud, public cloud, hybrid cloud, and so forth. In this description and in the claims, a “cloud-computing environment” is an environment in which cloud computing is employed.

In one example, a computing device may be configured to perform one or more of the processes described above. the computing device can comprise a processor, a memory, a storage device, an I/O interface, and a communication interface, which may be communicatively coupled by way of a communication infrastructure. In certain embodiments, the computing device can include fewer or more components than those described above.

In one or more embodiments, the processor includes hardware for executing instructions, such as those making up a computer program. As an example and not by way of limitation, to execute instructions for digitizing real-world objects, the processor may retrieve (or fetch) the instructions from an internal register, an internal cache, the memory, or the storage device and decode and execute them. The memory may be a volatile or non-volatile memory used for storing data, metadata, and programs for execution by the processor(s). The storage device includes storage, such as a hard disk, flash disk drive, or other digital storage device, for storing data or instructions related to object digitizing processes (e.g., digital scans, digital models).

The I/O interface allows a user to provide input to, receive output from, and otherwise transfer data to and receive data from computing device. The I/O interface may include a mouse, a keypad or a keyboard, a touch screen, a camera, an optical scanner, network interface, modem, other known I/O devices or a combination of such I/O interfaces. The I/O interface may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface is configured to provide graphical data to a display for presentation to a user. The graphical data may be representative of one or more graphical user interfaces and/or any other graphical content as may serve a particular implementation.

The communication interface can include hardware, software, or both. In any event, the communication interface can provide one or more interfaces for communication (such as, for example, packet-based communication) between the computing device and one or more other computing devices or networks. As an example and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI.

Additionally, the communication interface may facilitate communications with various types of wired or wireless networks. The communication interface may also facilitate communications using various communication protocols. The communication infrastructure may also include hardware, software, or both that couples components of the computing device to each other. For example, the communication interface may use one or more networks and/or protocols to enable a plurality of computing devices connected by a particular infrastructure to communicate with each other to perform one or more aspects of the digitizing processes described herein. To illustrate, the image compression process can allow a plurality of devices (e.g., server devices for performing image processing tasks of a large number of images) to exchange information using various communication networks and protocols for exchanging information about a selected workflow and image data for a plurality of images.

It should initially be understood that the disclosure herein may be implemented with any type of hardware and/or software, and may be a pre-programmed general purpose computing device. For example, the system may be implemented using a server, a personal computer, a portable computer, a thin client, or any suitable device or devices. The disclosure and/or components thereof may be a single device at a single location, or multiple devices at a single, or multiple, locations that are connected together using any appropriate communication protocols over any communication medium such as electric cable, fiber optic cable, or in a wireless manner.

It should also be noted that the disclosure is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the disclosure, or divided into additional modules based on the particular function desired. Thus, the disclosure should not be construed to limit the present invention, but merely be understood to illustrate one example implementation thereof.

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer to-peer networks).

The operations described in this specification can be implemented as operations performed by a “control system” on data stored on one or more computer-readable storage devices or received from other sources.

The term “control system” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A radio access network comprising:
a first near real time radio access network intelligent controller having a first network address;
a second near real time radio access network intelligent controller having a second network address;
an E2 node in network communication with the first near real time radio access network intelligent controller, wherein the E2 node includes a configuration file with the first network address; and
wherein a re-dispatch procedure is executed to supply the second network address to the E2 node to update the configuration file, and network communication is established between the second near real time radio access network intelligent controller and the E2 node.

2. The system of claim 1, further comprising a non-real time radio access network intelligent controller coupled to the first and second near real time radio access network intelligent controllers, wherein the second near real time radio access network intelligent controller is selected by the non-real time radio access network intelligent controller from a plurality of near real time radio access network controllers.

3. The system of claim 1, wherein the first near real time radio access network intelligent controller initiates the re-dispatch procedure, wherein the configuration file of the E2 node is updated with the second network address from the first near real time radio access network intelligent controller.

4. The system of claim 2, wherein the second near real time radio access network intelligent controller initiates the re-dispatch procedure when the first near real time radio access network intelligent controller fails.

5. The system of claim 4, wherein the E2 node receives the second network address from the second near real time radio access network intelligent controller during the re-dispatch procedure.

6. The system of claim 1, wherein the E2 node is one of a plurality of E2 nodes supported by the first near real time radio access network intelligent controller.

7. The system of claim 1, wherein the first near real time radio access network intelligent controller is in compliance with the O-RAN standard.

8. A method of supporting E2 nodes in a mobile communication network, the method comprising:
establishing network communication between an E2 node with a first near real time radio access network intelligent controller, wherein the E2 node includes a configuration file with a first network address of the first near real time radio access network intelligent controller;
executing a re-dispatch procedure to supply a second network address of a second near real time radio access network intelligent controller to the E2 node; and
establishing network communication between the E2 node and the second near real time radio access network intelligent controller.

9. The method of claim 8, wherein the second near real time radio access network intelligent controller is selected from a plurality of near real time radio access network controllers by a non-real time radio access network intelligent controller coupled to the first and second near real time radio access network intelligent controllers.

10. The method of claim 8, wherein the first near real time radio access network intelligent controller initiates the re-dispatch procedure, wherein the configuration file of the E2 node is updated with the second network address.

11. The method of claim 8, wherein the second near real time radio access network intelligent controller initiates the re-dispatch procedure when the first near real time radio access network intelligent controller fails.

12. The method of claim 11, wherein the E2 node receives the second network address during the re-dispatch procedure.

13. The method of claim 8, wherein the E2 node is one of a plurality of E2 nodes supported by the first near real time radio access network intelligent controller.

14. The method of claim 8, wherein the first near real time radio access network intelligent controller is in compliance with the O-RAN standard.

15. A near-real time radio access network intelligent controller for servicing E2 nodes in a radio access network, the near-real time radio access network intelligent controller comprising:
a network interface allowing communication to a first E2 node through an E2 network interface;
a database storing an IP address of another radio access network intelligent controller in the radio access network and the IP address of the first E2 node and a second E2 node;
a controller operable to:
execute a network function for the first E2 node through the network interface;
execute a re-dispatch procedure that communicates with the first E2 node over the network interface to reconfigure a configuration file of the first E2 node with the IP address of the another radio access network intelligent controller;
establish a communication with the second E2 node;
execute the re-dispatch procedure to reconfigure a configuration file of the second E2 node with an IP address of the radio access network intelligent controller; and
terminate the communication with the second E2 node.

16. The near-real time radio access network intelligent controller of claim 15, wherein the controller is further operable to:
determine a decrease in execution of the network function;
initiate a request to the first E2 node to establish communication with the another near-real time radio access network intelligent controller; and
terminate the network communication with the first E2 node.

17. The near-real time radio access network intelligent controller of claim 15, wherein the controller is further operable to:
receive a connection request from the second E2 node;
establish communication with the second E2 node; and
perform the network function for the second E2 node.

18. The near-real time radio access network intelligent controller of claim 17, further comprising another network interface in communication with a non-real time radio access network intelligent controller, wherein the near real time radio access network intelligent controller is selected by the non-real time radio access network intelligent controller from a plurality of near real time radio access network controllers to receive the connection request from the second E2 node.

19. The near-real time radio access network intelligent controller of claim 15, wherein the first E2 node is one of a plurality of E2 nodes supported by the near real time radio access network intelligent controller.

20. The near-real time radio access network intelligent controller of claim 15, wherein the near real time radio access network intelligent controller is in compliance with the O-RAN standard.
